(19) United States
(12) Patent Application Publication
(10) Pub. No.: US 2002/0010816 A1
(43) Pub. Date: Jan. 24, 2002

(54) COMPUTER PERIPHERAL SWITCHING DEVICE

(76) Inventor: PATRICK H. TOMOSON, DAKOTA CITY, NE (US)

Correspondence Address: SCHWEGMAN LUNDBERG WOESSNER & KLUTH, P O BOX 2938, MINNEAPOLIS, MN, 55402

(21) Appl. No.: 08/992,974

(22) Filed: Dec. 18, 1997

(51) Int. Cl. G06F 3/00; G06F 3/02; G06F 3/023

(52) U.S. Cl. 710/36

(57) ABSTRACT

A pointing device, such as a mouse or trackball, incorporates a selection switch, such as a button, that signals switching circuitry external to the pointing device to switch the connections of the device from one computer to another. Optionally, the selection switch also switches an additional peripheral between computers. A second input device, such as a keyboard, incorporates a second selection switch and activating any selection switch signals the switching circuitry to switch both input devices and any additional peripheral to a different computer.

### FIELD OF THE INVENTION

The present invention is related to computer input devices and in particular to an input device that controls switching circuitry for computer peripherals.

### BACKGROUND OF THE INVENTION

In an environment such as a network server control room, a computer user needs to control multiple computers. Each computer is usually equipped with a monitor and input devices such as a keyboard and a pointing device. However, the duplication of monitors and input devices among the computers is costly in terms of money and space. In an effort to reduce these costs, manufacturers have devised switching circuitry which switches the connections of a single monitor, a single keyboard, and/or a single pointing device among a number of computers. The switching operations are controlled through buttons or knobs built into a box containing the circuitry. The size of the box depends on the number of computers connected to the switch since the amount of switching circuitry increases proportionally as the number of computers increases.

Thus in order to switch the monitor, keyboard, and/or pointing device from one computer to another, the user must either move to where the switch box is located or place the switch box near his/her desk. Either solution is unsatisfactory. The first option means the user cannot quickly switch among many computers and the second option takes up premium space on or near the user's desktop.

One solution to the above problem is presented by switch boxes which are controlled using a key sequence input by the user at the keyboard. The switch box intercepts the scan code generated by the key sequence and switches the selected peripherals to the next computer in sequence. One family of such switch boxes are the ServSwitches from Black Box Inc. However, the user must remember the precise key sequence and must ensure that the sequence is not used by any software packages that execute on the computers controlled by the switch box.

There is a need for a switching device that allows control of multiple computers from a single location convenient to the user, does not interfere with software running on the computers, and which does not take up valuable space near the user.

### SUMMARY OF THE INVENTION

A pointing device, such as a mouse, trackball, or graphics tablet, incorporates a selection switch, such as a button, that signals switching circuitry external to the pointing device to switch the connections of input devices, such as the pointing device and a keyboard, from one computer to another. Optionally, the selection switch also switches an additional peripheral, such as a computer monitor, between computers.

The switching circuitry is coupled to the pointing device and has at least two ports for coupling to computers. The selection switch is also coupled to the switching circuitry. Activating the selection switch signals the switching circuitry to couple the input devices to a selected one of the ports and thus to one of the computers. The additional peripheral is also coupled to the switching circuitry so that it is coupled to the selected one of the ports when the selection switch is activated.

The selection switch signals the switching circuitry through an additional line in a cable that couples the pointing device to the switching circuitry, or through an electromagnetic signal generated when the selection switch is activated.

The selection switch also includes a mechanism to prevent its inadvertent activation.

Additionally, the pointing device and another input device, such as a keyboard, each incorporate a selection switch and activating either selection switch signals the switching circuitry to switch both input devices and any additional peripheral to a different port.

Because the selection switch and the switching circuitry are physically separate and because the selection switch is incorporated into a pointing device already existing on the user's desktop, the present invention overcomes the limitations of the prior art by permitting the user to switch input devices and a peripheral among computers from a single location without taking up additional desk space and without potential interference with software executing on the computers.

### BRIEF DESCRIPTION OF THE DRAWINGS

FIG. 1 is a block diagram of one embodiment of a computer peripheral switching device in which the pointing device is a mouse.

FIG. 2 is a block diagram of an alternate embodiment of the embodiment of FIG. 1 showing a different location for a control button on the mouse.

FIG. 3 is a block diagram showing both a mouse and a keyboard controlling computer peripheral switching circuitry.

FIG. 4 is a block diagram of an alternate embodiment of FIG. 3 which also controls connections for a computer monitor.

FIG. 5 is a block diagram of an alternate embodiment of the computer peripheral switching device in which the pointing device is remotely coupled to the switch box.

FIG. 6 is a block diagram of an alternate embodiment of the computer peripheral switching device in which a microprocessor is coupled between the pointing device and the switching circuitry.

FIG. 7 is a field layout diagram for a data packet sent by one embodiment of the computer peripheral switching device to the switching circuitry.

### DESCRIPTION OF THE EMBODIMENTS

In the following detailed description of the embodiments, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the present inventions. The following detailed description is, therefore, not to be taken in a limiting sense, and the scope of the present inventions is defined only by the appended claims.

The leading digits of reference numbers appearing in the Figures corresponds to the Figure number, with the exception that the same reference number is used throughout to refer to an identical component which appears in multiple Figures. Signals and connections may be referred to by the same reference number or label, and the actual meaning will be clear from its use in the context of the description.

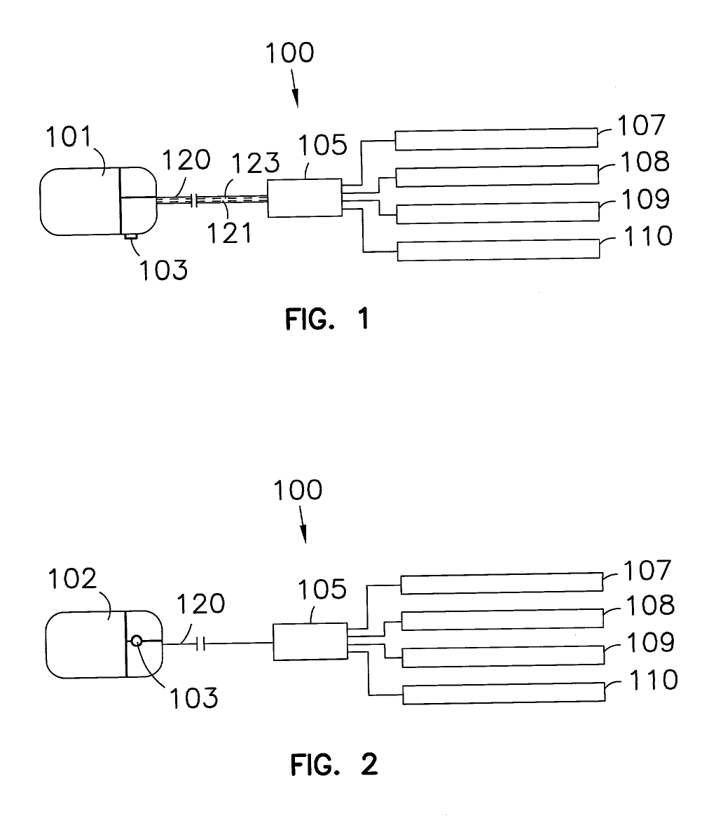

FIG. 1 is a block diagram of one embodiment of a computer peripheral switching device 100 in which a pointing device 101 is represented generically as a mouse. Switching circuitry 105 is coupled to the mouse 101 through a cable 120 containing industry standard signal lines 121 for a serial pointing device. The switching circuitry 105 in the embodiment shown in FIG. 1 comprises four serial ports 107-110 which are in turn coupled to serial ports on four computer systems (not shown). Alternate embodiments in which the switching circuitry switches a single input device among more or fewer than four computer systems will be apparent to those skilled in the art as will embodiments incorporating non-serial protocols. Commonly available switching circuitry has the capability to switch one device among multiple ports as required by the invention and is therefore not described further herein. Some circuits incorporate manually rotated switches. In such devices, an actuator is provided which rotates the switch in response to selected signals. One example of readily available switching circuitry can be found in Black Box Inc.'s SW623A product.

A selection switch 103 is located on a side of the mouse 101 where it is convenient to the user. The selection switch 103 is coupled to the switching circuitry 105 through an additional signal line 123 integrated into the cable 120. When the user activates the selection switch 103, a signal is sent to the switching circuit to cause it to couple the serial lines 121 in the cable 120 to the serial ports 107-110, thus completing a connection between the mouse 101 and the computer system coupled to the selected port.

In the embodiment illustrated in FIG. 1, the selection switch 103 is a push button manufactured into the side of the mouse case. Pressing on the push button sends the signal to the switching circuitry to couple the mouse 101 to one of the ports 107-110. Each time the push button is pressed, a different one of the ports 107-110 is coupled to the mouse 101 so that the user can rotate the use of the mouse 101 among the computers coupled to ports 107-110. Alternately, the push button shown in FIG. 1 is replaced by a sliding button in which each different position of the sliding button corresponds to one of the ports 107-110. In a further alternate embodiment, a wheel is used in place of the push button. In yet another embodiment, two selection switches are incorporated into the pointing device; pressing one of the selection switches moves forward through the sequence of computers while pressing the other moves backwards through the sequence.

In addition, the location of the selection switch 103 is not limited to the side of the mouse 101. One alternate embodiment in which the selection switch 103 is placed between standard command buttons on top of a mouse 102 is shown in FIG. 2. In the alternate embodiment illustrated in FIG. 2, the selection switch 103 can any of the mechanisms described above. Furthermore, when the selection switch 103 is located on top of the mouse 102, the selection switch 103 can operate similarly to a joystick (or a miniature pointing stick) in which the user rotates the selection switch 103 through a 360° circle. Positions on the circle correspond to the ports 107-110. Further alternate embodiments for associating the position of the selection switch 103 with the ports 107-110 will be apparent to those skilled in the art.

Inadvertent activation of the selection switch 103 can be prevented by increasing the resistance of a contact mechanism, such as using a spring with a high spring constant, attached to the selection switch 103 such that more than casual force is needed to activate the selection switch 103. Such a contact mechanism is applicable to both the push button and the slide switch embodiments. Other commonly available mechanisms which are less susceptible to inadvertent activation than toggle-like push buttons are suitable for use as the selection switch 103 as will be apparent to those skilled in the art. Requiring a combination of movements, such as pushing in the selection switch 103 while simultaneously moving it to a different position, defines still another alternate embodiment that prevents inadvertent activation.

In another aspect of the invention shown in FIG. 6, activating the selection switch 103 sends a serial data packet on the standard serial lines 121 in the cable 620 to the switching circuitry 105. A microprocessor 601, such as a Hitachi H8 controller, coupled to the switching circuitry 105, recognizes the data packet as a signal to connect the serial lines 121 from the pointing device 101 to one of the ports 107-110 and thus to the serial port of one of the computers. In this embodiment, the additional signal line 123 shown in FIG. 1 is unnecessary. Alternatively, in a further embodiment not illustrated, the serial data packet is passed through the switching circuitry 105 to the selected computer. A device driver active in the currently selected computer processes the data packet and signals the switching circuitry 105 to switch the input device 101 to another one of the ports 107-110. The microprocessor 601 is not necessary because the central processing unit of the selected computer processes the data packet instead. An example data packet 700, illustrated in FIG. 7, contains a packet identifier 701 to distinguish it as a switching control packet and a port identifier 703 which designates which port 107-110 is to be coupled to the input device 101. In a further embodiment not illustrated, the port identifier 703 is sent as part of a standard input device data packet such as used to signal cursor movements and button states to the microprocessor 601 as is well known in the art.

The device driver or equivalent software running in the computer systems coupled to the ports 107-110, such as Plug-n-Play® software included in Windows 95®, permits the disconnection and re-connection of input devices without rebooting the computers. Alternatively, for systems which do not incorporate such software, the switching circuitry 105 transmits signals to the non-selected computer systems to emulate a connected but inactive input device. As both methods of enabling input devices to be connected and disconnected without rebooting a computer are well-known in the art, they are not illustrated or described further herein.

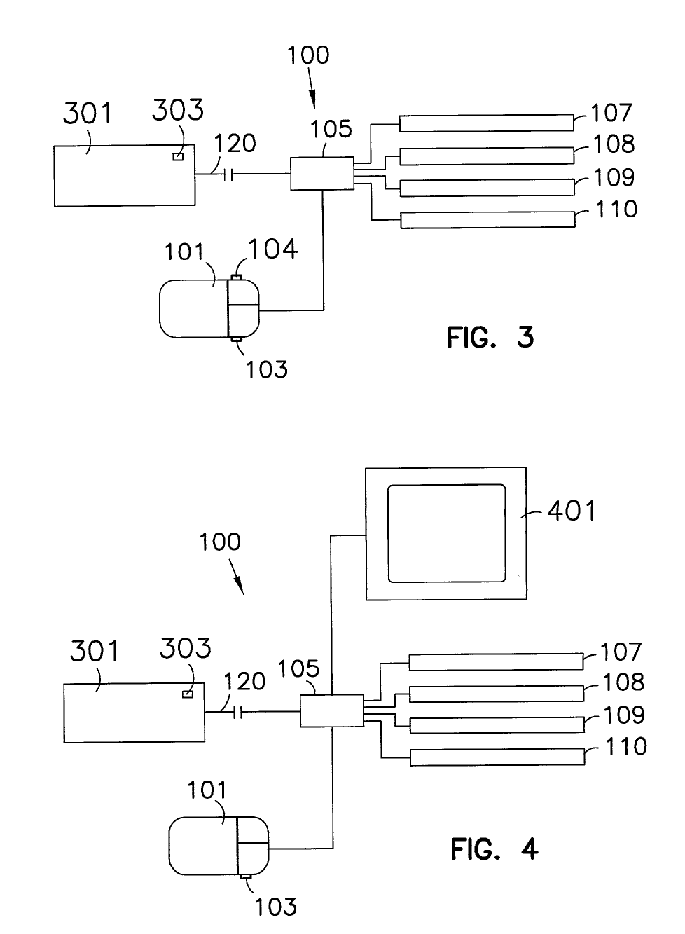

The invention is not limited to control from a single device. FIG. 3 is a block diagram of an alternate embodiment of the computer peripheral switching device in which the mouse 101 of FIG. 1 and a keyboard 301 both control the switching circuitry. The keyboard 301 is a specially-manufactured keyboard with a key 303 acting as the selection switch. Activating either the button 103 on the mouse or the key 303 on the keyboard signals the switching circuitry 105 to switch both the mouse 101 and the keyboard 301 to one of the ports 107-110.

Furthermore, in an additional embodiment shown in FIG. 4, a peripheral 401, illustrated generically as a computer monitor, is coupled to the switching circuitry 105 so that the peripheral is also switched to the selected computer when the mouse 101 and the keyboard 301 are switched. The switching of peripherals other than a computer monitor as shown in FIG. 4 will be readily apparent to one skilled in the art.

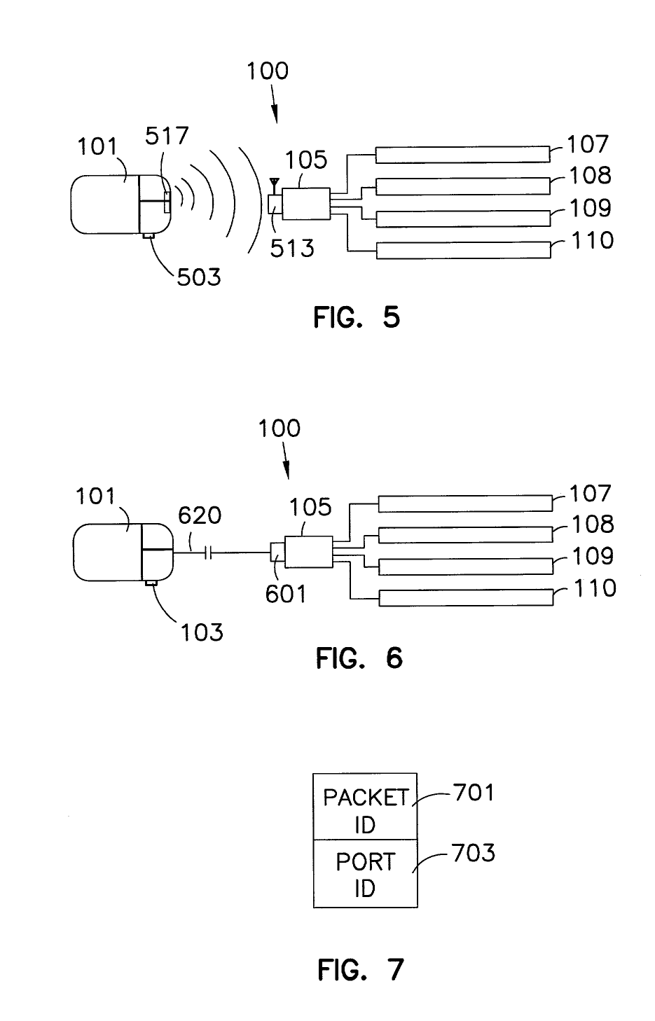

FIG. 5 illustrates yet another alternate embodiment of the invention in which the pointing device 501, again shown as a mouse, is not physically connected to the switching circuitry 105, but instead is coupled through the use of an electromagnetic signal 515 generated by an emitter 517 positioned within the pointing device 501. The emitter is coupled to the selection switch 503 so that when the selection switch 503 is activated the signal 515 is transmitted. A receiver 513, coupled to the switching circuitry 105, receives the signal 515 and routes it to the switching circuitry 105. The signal 515 can correspond to the signal sent through the additional signal line 123 (FIG. 1), or multiple signals 515 can form a serial data packet 700 (FIG. 7) for processing by a microprocessor 601 (FIG. 6) or by the currently selected computer as explained above. Electromagnetic receivers and emitters with the necessary capabilities, such as model numbers BPV22BF (receiver) and TS1P5201 (emitter) from Telefunken of Germany that work in the infrared portion of the electromagnetic spectrum, and radio frequency transceiver A5980800/R567121 from Mitsumi Japan, are standard off-the-shelf components in the industry and are not discussed further.

It is to be understood that the above description is intended to be illustrative, and not restrictive. Many other embodiments will be apparent to those of skill in the art upon reviewing the above description. For example, multiple and different types of switching circuitry are capable of switching between devices can be used. The only required functionality of such circuitry is that it is capable of accepting signals and switching in response to the signals. The scope of the invention should, therefore, be determined with reference to the appended claims, along with the full scope of equivalents to which such claims are entitled.

What is claimed is:

1. A computer peripheral switching device comprising:
switching circuitry externally located from and coupled to a pointing device and further having at least two ports for coupling to computers;
a first selection switch located on the pointing device and communicatively coupled to the switching circuitry, whereby activating the selection switch signals the switching circuitry to couple the pointing device to a selected one of the ports.

2. The computer peripheral switching device of claim 1, further comprising an additional computer peripheral coupled to the switching circuitry such that activating the selection switch signals the switching circuitry to couple the peripheral to the selected one of the ports.

3. The computer peripheral switching device of claim 2, wherein the additional peripheral is a computer monitor.

4. The computer peripheral switching device of claim 1, wherein the selection switch is located on a side of the pointing device.

5. The computer peripheral switching device of claim 1, wherein the selection switch is located on a top surface of the pointing device between two command buttons.

6. The computer peripheral switching device of claim 1, wherein the pointing device is a mouse.

7. The computer peripheral switching device of claim 1, wherein the pointing device is a pen-based input device.

8. The computer peripheral switching device of claim 1, further comprising a keyboard coupled to the switching circuitry, the keyboard comprising a second selection switch communicatively coupled to the switching circuitry, wherein activating either the first or second selection switches signals the switching circuitry to coupled the pointing device and the keyboard to the selected one of the ports.

9. The computer peripheral switching device of claim 8, wherein the second selection switch selection switch is a key on the keyboard.

10. The computer peripheral switching device of claim 1, wherein the selection switch is activated by a force unlikely to be inadvertently applied.

11. The computer peripheral switching device of claim 1, wherein the selection switch switches among the ports in a pre-defined sequence.

12. The computer peripheral switching device of claim 1, wherein the selection switch has at least two positions, with each position corresponding to a certain one of the ports.

13. The computer peripheral switching device of claim 1, wherein the selection switch signals the switching circuitry by sending a signal through a line within a cable that connects the pointing device to the switching circuitry.

14. The computer peripheral switching device of claim 1, wherein the selection switch signals the switching circuitry by sending a data packet through a cable connecting the pointing device to the switching circuitry.

15. The computer peripheral switching device of claim 1, wherein the selection switch signals the switching circuitry by transmitting an electromagnetic signal to a sensor coupled to the switching circuitry.

16. The computer peripheral switching device of claim 15, wherein the electromagnetic signal comprises a data packet.

17. The computer peripheral switching device of claim 15, wherein the electromagnetic signal lies in the infrared frequency range of the electromagnetic spectrum.

18. The computer peripheral switching device of claim 15, wherein the electromagnetic signal lies in radio frequency range of the electromagnetic spectrum.

19. A peripheral switching system comprising:
switching circuitry externally located from and coupled to first and second input devices and further having at least two ports for coupling to computers;
first and second selection switches located on the first and second input devices respectively, whereby activating one of the selection switches signals the switching circuitry to couple the first and second input devices to a selected one of the ports.

20. The peripheral switching system of claim 19, further comprising an additional computer peripheral coupled to the switching circuitry such that activating one of the selection switches signals the switching circuitry to couple the additional peripheral to the selected one of the ports.

21. The peripheral switching system of claim 19, wherein at least one of the first or second selection switches switches among the ports in a pre-defined sequence.

22. The peripheral switching system of claim 19, wherein at least one of the first or second selection switches has at least two positions, with each position corresponding to a certain one of the ports.

23. The peripheral switching system of claim 19, wherein at least one of the first or second selection switches signals the switching circuitry by sending a signal through a line within a cable that connects the input device to the switching circuitry.

24. The peripheral switching system of claim 19, wherein at least one of the first or second selection switches signals the switching circuitry by sending a data packet through a cable connecting the input device to the switching circuitry.

25. The peripheral switching system of claim 19, wherein at least one of the first or second selection switches signals the switching circuitry by transmitting an electromagnetic signal to a receiver coupled to the switching circuitry.

26. The peripheral switching system of claim 25, wherein the electromagnetic signal comprises a data packet.

27. The computer peripheral switching device of claim 25, wherein the electromagnetic signal lies in the infrared frequency range of the electromagnetic spectrum.

28. The computer peripheral switching device of claim 25, wherein the electromagnetic signal lies in radio frequency range of the electromagnetic spectrum.

29. A computer system comprising:
a plurality of processing devices;
a switch coupled to the processing devices that switches between the processing devices; and
an pointing device remotely coupled to the switch and to a processing device, the pointing device comprising a selection switch that generates a selection signal when activated by a user, wherein the switch is responsive to the selection signal to couple the pointing device to a different processing device.

30. A computer system comprising:
a plurality of processing devices, each having an input bus;
a switch coupled to the input bus of each processing device, that switches between the busses; and
an pointing device remotely coupled to the switch and to the input bus of one processing device, the pointing device comprising a selection switch that generates a selection signal when activated by a user, wherein the switch is responsive to the selection signal to couple the pointing device to a different processing device input bus.

31. The computer system of claim 30 wherein each processing device is capable of receiving the selection signal when coupled to the pointing device and providing the selection signal to the switch.

32. The computer system of claim 30 wherein the pointing device comprises an RF emitter for broadcasting the selection signal, and wherein the switch comprises an RF receiver for receiving the broadcast selection signal.

33. A computer system comprising:
a plurality of processing devices, each having a bus;
a switch coupled to the bus of each processing device, that switches between the busses;
a peripheral device coupled to the switch; and
an pointing device remotely coupled to the switch and to the bus of one processing device, the pointing device comprising a selection switch that generates a selection signal when activated by a user, wherein the switch is responsive to the selection signal to couple the pointing device and the peripheral device to a different processing device bus.
